(19) United States
(12) Patent Application Publication
(10) Pub. No.: US 2006/0165924 A1
(43) Pub. Date: Jul. 27, 2006

(54) Automatically inflatable and erectable ornament structure

(76) Inventor: Teng-Hui Wu, Taipei City (TW)

Correspondence Address: BACON & THOMAS, PLLC, 625 SLATERS LANE, FOURTH FLOOR, ALEXANDRIA, VA, 22314, US

(21) Appl. No.: 11/039,844

(22) Filed: Jan. 24, 2005

(51) Int. Cl. B31B 45/00

(52) U.S. Cl. 428/34.1

(57) ABSTRACT

The present invention discloses an automatic inflatable and erectable ornament structure which includes a housing having stitches on its lateral sides, a airtight bag having two flat pieces, a liquid pad and a predetermined amount of chemical powder being placed between the two flat pieces, such that the ornament structure can be inflated by thumping into the housing to crack the liquid pad and mix a liquid contained in the liquid pad with the chemical powder to produce a gas as to inflate the airtight bag automatically; after the airtight bag expands into a three-dimensional ornament, the stitches are propped up and cracked to form support plates and thus the airtight bag is supported by the support plates to give rise to an erected condition of the ornament.

### FIELD OF THE INVENTION

The present invention relates to an ornament structure, more particularly to an ornament structure that can be inflated and erected automatically.

### BACKGROUND OF THE INVENTION

In general, an inflatable ornament comes with an airtight bag 4 in which a gas is filled as shown in FIG. 1, and the airtight bag 4 usually includes a gas-filling duct 41 being built into and exposed at a distance from the airtight bag 4, and the external surface of the gas-filling duct 41 is sealed with the internal surface of the airtight bag 4 at a corresponding position to achieve an airtight condition. In the meantime, the gas-filling duct 41 has a flat air passage, and the internal side of the flat air passage is painted with a printing ink (not shown in the figure) at an appropriate position close to the internal side of the flat air passage. Therefore, if a user wants to inflate the ornament, the user must insert an end of a slender spout (not shown in the figure) into the gas-filling duct 41 and all the way to the airtight bag 4, and then blow a gas into the airtight bag 4 from another end of the slender spout by mouth or by a gas blower. As soon as the airtight bag 4 is inflated into a three-dimensional object successfully, the user pulls out the slender spout immediately from the gas-filling duct 41. Then, the gas in the airtight bag 4 will automatically press the flat air passage inside the airtight bag 4 to achieve an airtight condition due to a pressure differential effect. In the meanwhile, the internal surface of the gas-filling duct 41 is painted with a printing ink and attached closely onto the flat air passage for preventing a gas leak.

After the traditional ornament is inflated and expanded into a three-dimensional object, users can wind the gas-filling duct 41 exposed at a distance out from the airtight bag 4 and tie it on a support base 6 of a support rod 5, so that the ornament can be fixed onto the support base 6 for its display or exhibition. A user must fill a gas into the airtight bag 4 of this kind of ornament by mouth or by a gas blower. After the gas is filled, a complicated procedure is required to fix the ornament onto the support base 6. However, if the gas adopted is not a light gas such as helium, then the user still cannot assure that the ornament can be securely erected on the support base 6 for a long time.

### SUMMARY OF THE INVENTION

In view of the shortcomings of the prior art, the inventor of the present invention based on years of experience in the related industry to conduct extensive researches and experiments to overcome the shortcomings of the prior art and finally invented the present invention.

Therefore, it is an objective of the present invention to provide an automatically inflatable and erectable ornament structure, and a user can inflate the ornament structure automatically by thumping into the ornament, such that the ornament gradually expands into a three-dimensional erected object. The ornament structure comprises a housing and an airtight bag, wherein a plurality of stitches is disposed on a lateral surface of the housing. The airtight bag is comprised of two flat pieces, a liquid pad (containing a citric acid) disposed between the two flat pieces and a specific amount of chemical powder (such as the backing soda powder), and the corresponding sides are sealed into an airtight condition, and only a protruded ear disposed at the corresponding end of the flat piece is not sealed together. After a double-sided tape is attached onto or glue is applied to the corresponding surfaces of the protruded ears, the bottom of the airtight bag is fixed in the housing corresponding to the internal edge of another side of the stitches. Therefore, when a user thumps into the ornament, the liquid pad breaks and the liquid in the liquid pad mixes with the chemical powder to produce a chemical reaction. The gas produced inflates the airtight bag automatically and gradually expands the airtight bag into a three-dimensional ornament. After the stitches prop up and break, the ornament is propped to a secured and erected condition as to produce an artistic and stably erected three-dimensional ornament in a simple, quick, and automatic fashion.

Another objective of the present invention is to provide a plurality of protruded ears, such that the bottom of the airtight bag can be fixed directly inside the housing corresponding to another side of the stitches.

A further objective of the present invention is to provide a plurality of protruded ears, such that the bottom of the airtight bag can be fixed onto the surface of a base. After the airtight bag is folded into the size of the base, the airtight bag and the base can be packaged together in the housing at a position opposite to the stitches on the housing.

Another further objective of the present invention is to provide a plurality of protruded ears, such that the bottom of the airtight bag can be fixed directly in the housing corresponding to another side of the stitches, and the transversal breadth of the airtight bag lies on the maximum diagonal of the housing to assure that the housing can fix a maximum bag of the ornament.

Another objective of the present invention is to provide a plurality of protruded ears such that the section of the airtight bag proximate to the protruded ears is smaller than the major section of the airtight bag to assure that when the airtight bag gradually expands to a three-dimensional object, a plurality of propping plates is formed along the stitches on a lateral side of the housing to prop up the airtight bag at the position proximate to the protruded ears as to support the weight of the airtight bag and keep it in a stably erected condition.

The above and other objects, features and advantages of the present invention will become apparent from the following detailed description taken with the accompanying drawings.

### BRIEF DESCRIPTION OF THE DRAWINGS

FIG. 1 is a schematic view of the structure of a prior-art inflatable ornament;

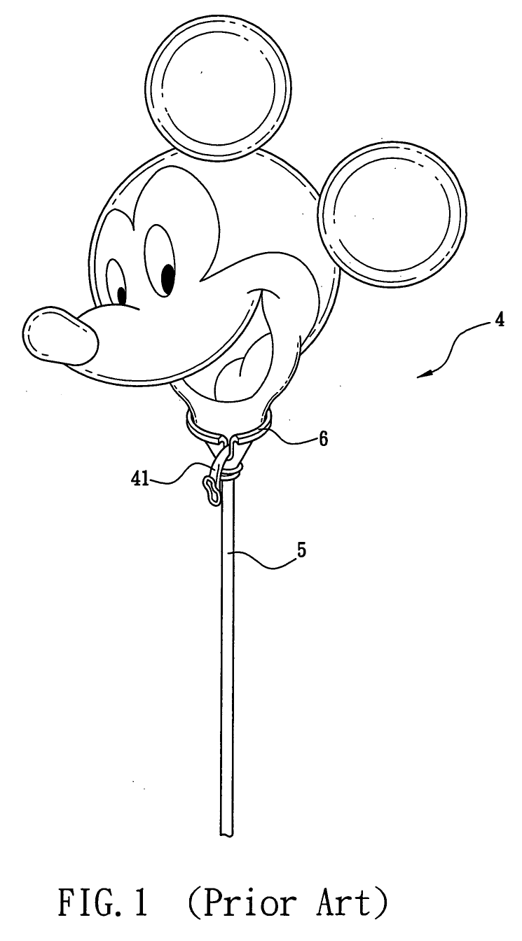

FIG. 2 is a schematic exploded view of the airtight bag of the invention;

FIG. 3 is a schematic view of the airtight bag assembly of the invention;

FIG. 4 is a schematic view of the airtight bag being installed into the housing according to the invention; and

FIG. 5 is a perspective view of the airtight bag being assembled with the housing according to the invention.

### DETAILED DESCRIPTION OF THE PREFERRED EMBODIMENTS

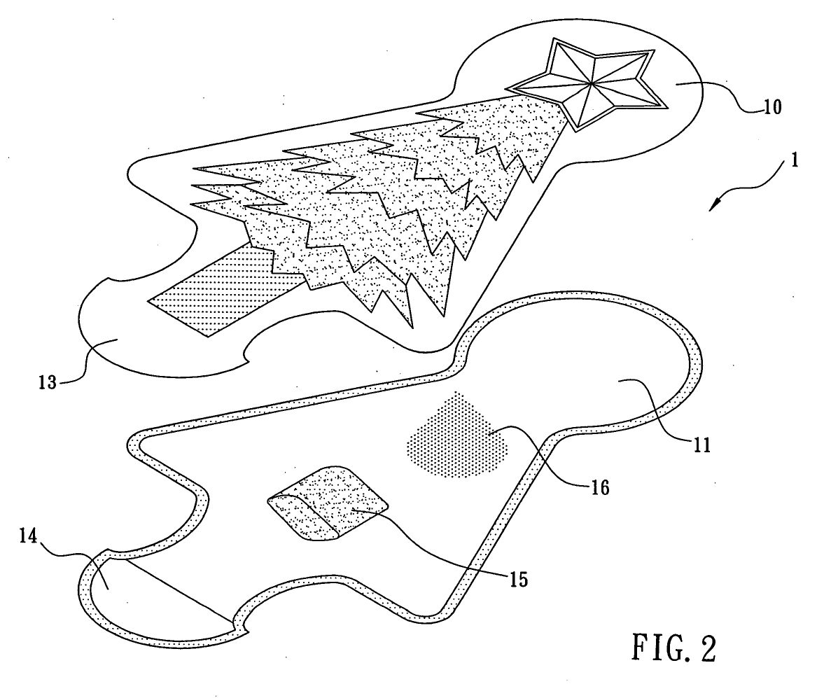

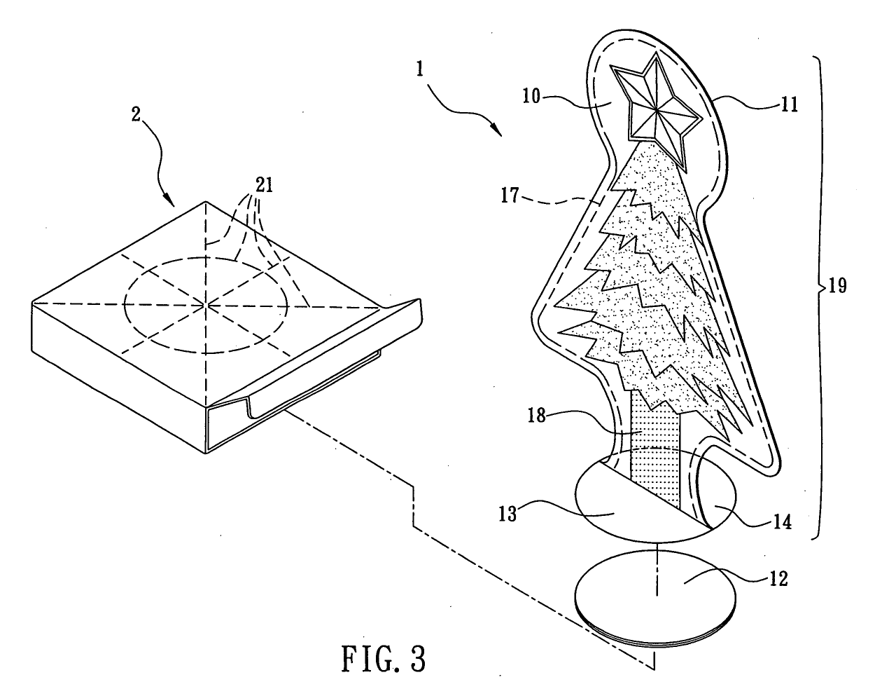

Please refer to FIGS. 2 and 3 for an automatic inflatable and erectable ornament structure according to a preferred embodiment of the present invention. The ornament structure comprises a housing 2 and an airtight bag 1; wherein the housing 2 is made of cardboard and printed with a desired decorative pattern, and a plurality of stitches 21 is disposed on a lateral surface; and the aright bag 1 is comprised of two flat pieces 10, 11 made of a plastic material, and the flat pieces have the desired stylish design of the ornament, and the desired pattern is printed on the two flat pieces 10, 11. A liquid pad 15 (containing a citric acid) and a specific amount of chemical powder 16 (such as a baking soda powder) are disposed between the two flat pieces 10, 11, and the corresponding edges 17 of the two flat pieces 10, 11 are sealed into an airtight condition by a hot press process, and only the protruded ears 13, 14 disposed at the corresponding ends of the flat pieces 10, 11 are not sealed together. Therefore, the bottom of the airtight bag 1 can be fixed directly inside the housing 2 corresponding to another lateral surface of the stitches 21, after the corresponding surfaces of the protruded ears 13, 14 are attached with a double-sided tape 12 or coated with a layer of glue. After the airtight bag 1 is folded and packaged into the housing 2, the ornament structure in accordance with the present invention is formed. If a user thumps into the ornament, the liquid pads 15 will breaks and the chemical liquid in the liquid pad 15 will flow out and evenly mix with the chemical power. After a chemical reaction of the chemical liquid and powder 16 takes place, the gas produced will automatically inflate the airtight bag 1 to gradually expand the airtight bag 1 into a three-dimensional ornament. After the stitches 21 are propped up and cracked, a stylish, artistic and securely erectable three-dimensional ornament is formed in a simple, quick and automatic fashion.

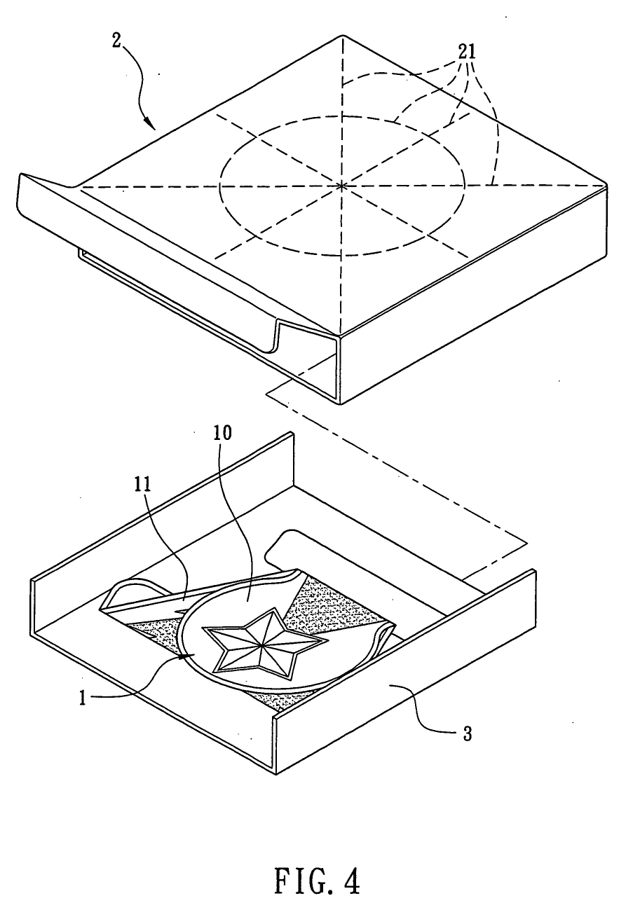

Please refer to FIG. 4 for another preferred embodiment of the present invention. To make the manufacture and assembling of the ornament structure easier, the housing 2 still maintains its strong structure, which will not be collapsed or deformed after being thumped by a user. A base 3, made of cardboard or other plastic materials, is designed, and has a size precisely fitted into the housing 2, so that the protruded ears 13, 14 let the bottom of the airtight bag 1 be fixed onto a surface of the base 3, and a user just needs to fold the airtight bag 1 into the size of the base 3 and puts it together with the base 3 into the housing 2, and the airtight bag 1 is disposed on the housing 2 at a position facing the stitches 21 as to produce the ornament structure in accordance with the present invention easily.

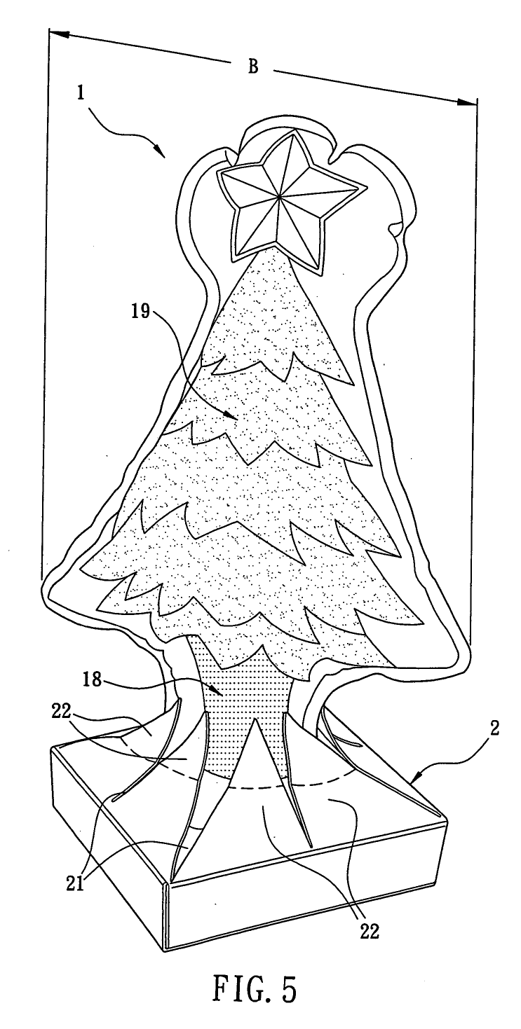

With reference to FIG. 5, it is noteworthy that when a user fixes the airtight bag 1 in the housing 2 corresponding to the internal edge of another lateral side of the stitches according to the foregoing preferred embodiment, the transversal breadth B is placed on the maximum diagonal of the housing 2 as to assure that a maximum airtight bag 1 can be fixed into the housing 2. Therefore, after the user thumps into the housing 2, a large securely erected three-dimensional ornament is formed automatically and quickly. In addition, the airtight bag 1 gradually expands to a securely erected condition according to the foregoing preferred embodiment. The section 18 of the airtight bag 1 proximate to the protruded ears is smaller than the major section 19 of the airtight bag 1 as to assure that the stitches disposed on a lateral side of the housing 2 are propped up and cracked to produce a plurality of support plates 22 when the airtight bag 1 gradually expands into a three-dimensional object, and each support plate 22 supports the airbag 1 precisely at the position 18 proximate to the protruded ears as to support the weight of the major section 19 of the airtight bag 1 and maintain the ornament structure in a securely erected condition.

In view of the above description, when a user wants to inflate the stylish ornament, no tool (such as a gas-filling duct or a gas blower) is required. The user simply thumps into the housing 2 of the ornament having the stitches on a lateral surface, such that the liquid pad 15 cracks and mixes evenly with the chemical powder 16 to produce a gas as to inflate the airtight bag automatically. After the airtight bag 1 gradually expands to a three-dimensional ornament, the stitches 21 are propped up and cracked, and the airtight bag 1 is supported by the support plates that gives rise to an erected condition and achieves the purpose of forming an erected three-dimensional ornament in a simple, quick and automatic fashion.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An automatically inflatable and erectable ornament structure, comprising:
a housing, having a plurality of stitches disposed on the surface on one side;
an airtight bag, being comprised of two flat pieces, and a liquid pad and a predetermined amount of chemical powder being placed between said two flat pieces, and a gas being produced when the liquid in said liquid pad is mixed with said chemical powder, and the corresponding edges of said two flat pieces being sealed into an airtight condition such that a protruded ear disposed on the corresponding end of said each flat piece remaining unsealed with each other;
thereby, the bottom of said airtight bag is fixed in said housing at the internal edge of another side corresponding to said stitch, after the corresponding surface of said protruded ear is attached with a layer of glue.

2. The automatically inflatable and erectable ornament structure of claim 1, wherein said liquid pad is a pad containing a citric acid.

3. The automatically inflatable and erectable ornament structure of claim 2, wherein said chemical powder is a baking soda powder.

4. The automatically inflatable and erectable ornament structure of claim 1, wherein said protruded ear is fixed directly into said housing on the surface corresponding to another side of said stitch, such that said airtight bag is contained into said housing after being folded.

5. The automatically inflatable and erectable ornament structure of claim 1, wherein said protruded ear is fixed onto the surface of a base, and said airtight bag together with said base are contained in said housing at a position facing said stitch after being folded into the size substantially equal to said base.

6. The automatically inflatable and erectable ornament structure of claims 4, wherein said airtight bag has its transversal breadth disposed on a maximum diagonal of said housing after said protruded ear is fixed into said housing corresponding to an internal edge of another side of said stitch.

7. The automatically inflatable and erectable ornament structure of claims 5, wherein said airtight bag has its transversal breadth disposed on a maximum diagonal of said housing after said protruded ear is fixed into said housing corresponding to an internal edge of another side of said stitch.

8. The automatically inflatable and erectable ornament structure of claim 1, wherein said airtight bag having a section proximate to said protruded ear is smaller than the major section of said airtight bag, such that when said airtight bag expands gradually into a three-dimensional ornament, a lateral surface of said housing is held open to produce a plurality of support plates along said each stitch to support the position of said protruded ear proximate to said airtight bag.
